(19) United States
(12) Patent Application Publication
(10) Pub. No.: US 2024/0278689 A1
(43) Pub. Date: Aug. 22, 2024

(54) HYBRID VEHICLE AND HIGH-VOLTAGE BATTERY CONTROL METHOD AND APPARATUS THEREFOR

(71) Applicant: SCHAEFFLER TECHNOLOGIES AG & CO. KG, Herogenaurach (DE)

(72) Inventor: Zhiming Li, Kunshan City (CN)

(73) Assignee: SCHAEFFLER TECHNOLOGIES AG & CO. KG, Herzogenaurach (DE)

(21) Appl. No.: 18/566,185

(22) PCT Filed: Jun. 4, 2021
(86) PCT No.: PCT/CN2021/098337

§ 371 Date: Dec. 1, 2023

(51) Int. Cl. B60L 58/27; B60L 58/20; B60W 20/40

(52) U.S. Cl. CPC B60L 58/27; B60L 58/20; B60W 20/40; B60L 2210/10; B60L 2240/421; B60L 2240/427; B60L 2240/545

(57) ABSTRACT

A high-voltage battery control method for a hybrid vehicle includes, when a main relay of a high-voltage battery of the hybrid vehicle is closed, controlling a driving motor of the hybrid vehicle so that a rotating speed of the driving motor reaches a first idle speed in response to determining that a predetermined condition is satisfied. The method further includes sending, to the high-voltage battery, a high-voltage disconnection instruction for disconnecting the main relay. The method further includes then controlling the driving motor so that the rotating speed of the driving motor reaches a second idle speed. Then second idle speed being greater than the first idle speed. The method further includes then; controlling the driving motor to output a predetermined voltage for heating the high-voltage battery.

### CROSS-REFERENCE TO RELATED APPLICATIONS

This application is the U.S. National Phase of PCT Appln. No. PCT/CN2021/098337 filed Jun. 4, 2021, the entire disclosure of which is incorporated by reference herein.

### TECHNICAL FIELD

The present disclosure relates to the technical field of hybrid vehicles, and in particular to a hybrid vehicle and a high-voltage battery control method and apparatus thereof.

### BACKGROUND

FIG. 1 is a structural schematic diagram of a powertrain of a hybrid vehicle in the related art. As shown in FIG. 1, the hybrid vehicle comprises a high-voltage battery, an engine, a k0 clutch, a driving motor and a gearbox. The k0 clutch is located between the engine and the driving motor. FIG. 2 is a structural schematic diagram of a system structure of a high-voltage battery. As shown in FIG. 2, the high-voltage battery can supply power to a motor controller and a Positive Temperature Coefficient (PTC) heating apparatus for heating the high-voltage battery. At the same time, a direct current power converter (DCDC) is used for supplying power to on-board low-voltage battery.

If the temperature of the high-voltage battery is too low (for example, the temperature of the high-voltage battery is lower than a threshold), the high-voltage battery cannot supply power to the hybrid vehicle. For this reason, the high-voltage battery needs to be preheated to increase the temperature thereof, thereby improving the discharge capacity of the high-voltage battery. Specifically, the high-voltage battery sends a heating request for heating the high-voltage battery to Hybrid Control Units (HCUs) through a Controller Area Network bus (CAN) message. The HCUs receive the heating request and sends to the high-voltage battery a closing instruction for closing a high-voltage relay and to a PTC heating apparatus a heating instruction for heating the high-voltage battery through a CAN message. The high-voltage battery responds to the received closing instruction to close the high-voltage relay. The PTC heating apparatus responds to the heating instruction to begin to heat the high-voltage battery. In such a scenario, the high-voltage battery is heated by its power (i.e., the high-voltage battery uses the PTC heating apparatus to preheat itself).

As mentioned above, if the temperature of the high-voltage battery is too low, the high-voltage battery uses the PTC heating apparatus to preheat itself, and the heating energy of the high-voltage battery comes from the power of the high-voltage battery. However, in some cases, if the power of the high-voltage battery is low; the high-voltage battery cannot use the low power to heat itself by using the PTC heating apparatus (i.e., to preheat the high-voltage battery). Further, if the temperature of the high-voltage battery is too low, the allowed charging power of the high-voltage battery is low, resulting in the inability to charge the high-voltage battery. Therefore, the high-voltage battery cannot supply power to the hybrid vehicle, which, as a result, is unable to move.

### SUMMARY

The present disclosure provides a hybrid vehicle and a high-voltage battery control method and apparatus thereof that overcome or at least alleviate the above defects in the prior art.

According to an exemplary embodiment of the present disclosure, a high-voltage battery control method of a hybrid vehicle is provided, which is applied to HCUs. The high-voltage battery control method includes: when a main relay of a high-voltage battery of a hybrid vehicle is closed, if a predetermined condition is satisfied, controlling a driving motor of the hybrid vehicle so that the rotating speed of the driving motor reaches a first idle speed; sending to the high-voltage battery a high-voltage disconnection instruction for disconnecting the main relay; controlling the driving motor so that the rotating speed of the driving motor reaches a second idle speed, the second idle speed being greater than the first idle speed; and controlling the driving motor to output a predetermined voltage for heating the high-voltage battery.

In embodiments, the predetermined condition includes: a heating request for heating the high-voltage battery is received, and the power of the high-voltage battery is less than or equal to a first calibration value.

In embodiments, the predetermined condition further includes: the hybrid vehicle is in a stationary state; and/or the allowed charging power of the high-voltage battery is less than or equal to a second calibration value.

In embodiments, after controlling the driving motor so that the rotating speed of the driving motor reaches a first idle speed, the control method further includes: detecting whether a PTC heating apparatus for heating the high-voltage battery is in a normal state: if the PTC heating device is in the normal state, sending to the high-voltage battery a high-voltage disconnection instruction for disconnecting the main relay.

In embodiments, the controlling the driving motor to output a predetermined voltage for heating the high-voltage battery includes: controlling the driving motor to supply the predetermined voltage to the PTC apparatus for heating the high-voltage battery via a power module of the driving motor.

The present disclosure further provides a high-voltage battery control apparatus of a hybrid vehicle. The high-voltage battery control apparatus includes: a first adjustment module for controlling the driving motor of the hybrid vehicle so that the rotating speed of the driving motor reaches a first idle speed if a predetermined condition is satisfied when a main relay of a high-voltage battery of the hybrid vehicle is closed; a communication module for sending to the high-voltage battery a high-voltage disconnection instruction for disconnecting the main relay: a second adjustment module for controlling the driving motor so that the rotating speed of the driving motor reaches a second idle speed, the second idle speed being greater than the first idle speed; and a control module for controlling the driving motor to output a predetermined voltage for heating the high-voltage battery.

In embodiments, the predetermined condition includes: the high-voltage battery control apparatus receives a heating request for heating the high-voltage battery, and the power of the high-voltage battery is less than or equal to a first calibration value.

In embodiments, the predetermined condition further includes: the hybrid vehicle is in a stationary state; and/or the allowed charging power of the high-voltage battery is less than or equal to a second calibration value.

In embodiments, the first adjustment module is further configured to: detect whether a PTC heating apparatus for heating the high-voltage battery is in a normal state after controlling the driving motor so that the rotating speed of the driving motor reaches a first idle speed; the communication module is further configured to: send to the high-voltage battery a high-voltage disconnection instruction for disconnecting the main relay if the first adjustment module detects that the PTC heating apparatus is in the normal state.

In embodiments, the control module is configured to control the driving motor to supply a predetermined voltage to the PTC apparatus for heating the high-voltage battery via a power module of the driving motor.

The present disclosure further provides a hybrid vehicle including: a high-voltage battery, a driving motor, and the high-voltage battery control apparatus as mentioned above.

According to the hybrid vehicle and the high-voltage battery control method and apparatus thereof of the present disclosure, the rotating speed of the driving motor reaches the first idle speed, and the main relay of the high-voltage battery is disconnected if a predetermined condition is satisfied when a main relay of the high-voltage battery is closed (when the predetermined condition is satisfied, the high-voltage battery cannot supply power to the hybrid vehicle: exemplarily, the predetermined condition may include but not limited to, for example, the power of the high-voltage battery is low and so does the temperature of the high-voltage battery): the rotating speed of the driving motor reaches the second idle speed greater than the first idle speed, and the driving motor outputs a predetermined voltage for heating the high-voltage battery. Therefore, compared with the prior art that the power of a high-voltage battery is used for preheating a high-voltage battery through a PTC heating apparatus to increase the temperature of the high-voltage battery and supply power to the hybrid vehicle, the present disclosure has the advantage that the high-voltage battery is heated by the predetermined voltage output by the driving motor regardless of the power of the high-voltage battery, so as to increase the temperature of the high-voltage battery and supply power to the hybrid vehicle. So it can avoid the situation that the hybrid vehicle is unable to move due to the failure of high-voltage battery to supply power to the hybrid vehicle.

Other features and aspects of the present disclosure will become clear according to the following detailed descriptions of exemplary embodiments with reference to drawings.

### BRIEF DESCRIPTION OF THE DRAWINGS

The drawings included in the specification and constituting a part thereof together with the specification illustrate exemplary embodiments, features, and aspects of the present disclosure, and are used to explain the principles of the present disclosure.

FIG. 1 is a structural schematic diagram of a powertrain of a hybrid vehicle in the related art.

FIG. 2 is a schematic diagram of a system structure of a high-voltage battery in the related art.

FIG. 3 is a flow diagram of a high-voltage battery control method of a hybrid vehicle according to one exemplary embodiment.

FIG. 4 is a flow diagram of a high-voltage battery control method of a hybrid vehicle according to one exemplary embodiment.

FIG. 5 is a block diagram of a high-voltage battery control apparatus of a hybrid vehicle according to one exemplary embodiment.

### DETAILED DESCRIPTION

Various exemplary embodiments, features and aspects of the present disclosure will be described in detail below with reference to the drawings. The same reference numerals in the drawings indicate elements with the same or similar functions. Although various aspects of the embodiments are shown in the drawings, the drawings are not necessarily drawn to scale unless otherwise specified.

The dedicated word “exemplary” herein means “serving as an example, embodiment, or being illustrative.” Any embodiment described herein as “exemplary” is not necessarily construed as being superior to or better than other embodiments.

In addition, in order to better illustrate the present disclosure, numerous specific details are given in the following specific embodiments. Those skilled in the art will understand that the present disclosure can also be implemented without certain specific details. In some other examples, the methods, means, elements and circuits that are well known to those skilled in the art have not been described in detail, so as to highlight the gist of the present disclosure.

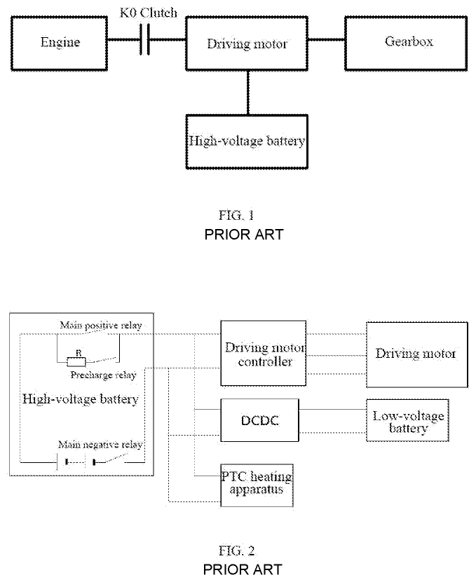

FIG. 2 is a schematic diagram of a system structure of a high-voltage battery applied to a hybrid vehicle. The hybrid vehicle may be an HEV or a PHEV. Exemplary, a power assembly of the hybrid vehicle may adopt the structure shown in FIG. 1, in which the hybrid vehicle may include a high-voltage battery, an engine, a k0 clutch, a driving motor and a gearbox. The k0 clutch is located between the engine and the driving motor, the voltage of the high-voltage battery is generally a high voltage of 100-400V, and the driving motor may be a P2 motor, for example.

In FIG. 2, a high-voltage battery system includes a main relay, a precharge relay and a precharge resistor R. The main relay includes a main positive relay on a positive side and a main negative relay on a negative side in the high-voltage battery system, respectively.

Among them, the precharge relay is a relay that can control the opening and closing of a precharge circuit, i.e., before the main relay operates, the precharge circuit performs self-checking. The precharge resistor R is equivalent to a protective resistor with a current limiting function, which can effectively prevent damage to other electronic components in the high-voltage battery system due to the large current at the moment of power-on.

Specifically, the starting process of the high-voltage battery is as follows:

If the hybrid vehicle needs to be powered on the high-voltage battery system is awakened, and it is in an initialization mode, and enters a self-checking state. If no fault is found, the high-voltage battery feeds back a pre-preparation state to HCUs and detects whether the main positive relay and the main negative relay are adhered (i.e., the main positive relay and the main negative relay cannot be disconnected). If neither the main positive relay nor the main negative relay is adhered, the high-voltage battery system is switched from an initialization mode to a standby mode and closes the precharge relay and the main negative relay to perform precharge for a certain period of time after receiving a high-voltage closing instruction sent by the HCUs. The precharge time is generally not greater than 600 ms. After completing precharge, the high-voltage battery system closes the main positive relay while disconnecting the precharge relay to complete the power-on process. At this time, the high-voltage battery system continuously supplies power to electrical apparatus (such as a driving motor, an ignition system, a vehicle air conditioner, various on-board instruments and auxiliary electrical apparatus) of the hybrid vehicle.

As shown in FIG. 2, the high-voltage battery can supply power for a driving motor controller and a PTC heating apparatus for heating the high-voltage battery. The motor controller is connected to the driving motor and used for controlling the driving motor. The driving motor can be a P2 motor, for example: at the same time, the high-voltage battery provides a low-voltage battery through a direct current power converter (DCDC) to supply power for low-voltage electrical apparatus (such as vehicle lights, various on-board instruments, a control system, small electrical appliances and other vehicle accessory equipment). The provided low-voltage battery can be, for example, a 12V low-voltage battery.

As described in the background art, if the temperature of the high-voltage battery is too low: the high-voltage battery uses the PTC heating apparatus to preheat itself, and the heating energy of the high-voltage battery comes from the power of the high-voltage battery. However, in some cases, if the power of the high-voltage battery is low, the high-voltage battery cannot heat itself through the low power. Furthermore, if the temperature of the high-voltage battery is too low: the allowed charging power of the high-voltage battery will be low so that the high-voltage battery cannot be charged, which in turn causes the failure of high-voltage battery to supply power to the hybrid vehicle. As a result, the hybrid vehicle cannot move. Accordingly, the disclosure provides a high-voltage battery control scheme for hybrid vehicles. With it, the high-voltage battery can be heated and started when the power of the high-voltage battery and the allowed charging power are low, thereby supplying power to the hybrid vehicle for its normal running.

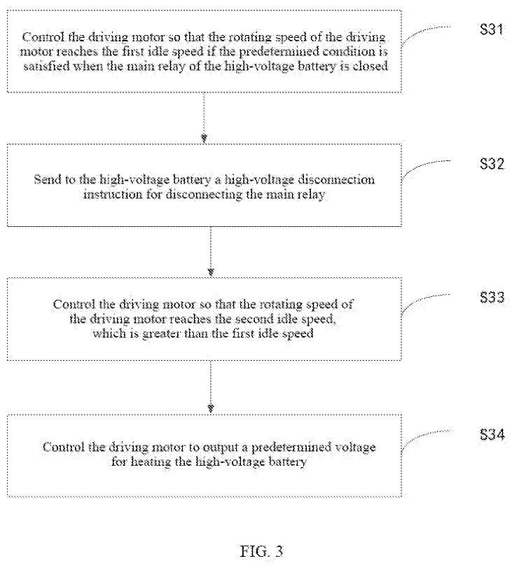

FIG. 3 is a flow diagram of a high-voltage battery control method of a hybrid vehicle according to one exemplary embodiment. The high-voltage battery control method can be applied to HCUs of hybrid vehicles. That is to say, the HCUs may achieve heating of the high-voltage battery of the hybrid vehicle by adopting the high-voltage battery control method in this implementation.

As shown in FIG. 3, the battery control method may include the following steps.

In step S31, when the main relay of the high-voltage battery is closed, if a predetermined condition is satisfied, the driving motor is controlled so that the rotating speed of the driving motor reaches a first idle speed.

In the embodiment of the present disclosure, the predetermined condition is that the high-voltage battery cannot use lower power to heat itself, but it can be specifically designed during specific implementation.

In one possible implementation, the above predetermined condition may include: condition 1: the HCUs receive a heating request for heating the high-voltage battery; condition 2: the power of the high-voltage battery is less than or equal to a first calibration value: when both condition 1 and condition 2 are met, it can be determined that the predetermined condition is satisfied. At this time, the high-voltage battery needs to be heated and cannot be heated through its low power.

In the embodiment of the present disclosure, the power of the high-voltage battery can be characterized by the actual power of the high-voltage battery, namely the remaining power in the high-voltage battery. At this time, it is common for a designer to flexibly determine the first calibration value based on the actual power of the battery when a vehicle cannot run normally, which can be expressed as a percentage rate of the actual power to the rated power of the high-voltage battery. For example, if the actual power of the high-voltage battery is less than or equal to 5%, it can be considered that the power of the high-voltage battery is less than or equal to the first calibration value.

In one possible implementation, the above predetermined condition may also include condition 3 and/or condition 4. Condition 3: the hybrid vehicle is in a stationary state; condition 4: the allowed charging power of the high-voltage battery is less than or equal to a second calibration value.

The second calibration value is an empirical value determined by the designer based on an actual physical state of the high-voltage battery. When the allowed charging power of the high-voltage battery is less than or equal to the second calibration value, it is determined that the high-voltage battery cannot be charged. When the predetermined condition includes Condition 4, the high-voltage battery needs to be heated, and it cannot be heated through its lower power or charged through a charger or other methods to increase its power.

In the embodiment of the present disclosure, for above-mentioned step S31, the HCUs can control the driving motor so that the rotating speed of the driving motor reaches the first idle speed by: sending a neutral instruction with a target gear being a neutral gear to a gearbox to switch the current gear to the neutral gear: sending to a clutch an engagement instruction for fully engaging the clutch to engage the clutch: sending to the driving motor a control mode instruction for setting the operating mode of the driving motor in a speed control mode and a first idle speed instruction for indicating a target speed to be the first idle speed to increase the rotating speed of the driving motor from zero to the first idle speed.

The gearbox can detect whether the current gear is a neutral gear in response to receiving the neutral instruction. If the current gear is the neutral gear, the gearbox will feed back to the HCUs a neutral state indicating that the current gear is the neutral gear: otherwise, if the current gear is not the neutral gear, the gearbox switches the current gear to the neutral gear and feeds back the neutral state to the HCUs.

As mentioned above, the HCUs can send the above-mentioned control mode instruction to the driving motor, which sets its operating mode in the speed control mode in response to receiving the control mode instruction; and the HCUs also sends the above-mentioned first idle speed instruction to the driving motor, which increases its rotating speed from zero to the first idle speed in response to receiving the first idle speed instruction. It should be understood that when the rotating speed of the driving motor reaches the first idle speed, the HCUs may send to the driving motor a control mode instruction to set the operating mode of the driving motor in a standby mode. Correspondingly, the driving motor sets its operating mode in the standby mode in response to receiving the control mode instruction.

The above implementation of controlling the driving motor so that the rotating speed of the driving motor reaches the first idle speed is only an example. This embodiment is not limited thereto. Those skilled in the art can use other related technologies in the prior art to ensure the driving motor reaches the first idle speed.

Since the clutch is fully engaged in response to receiving the engagement instruction for fully engaging the clutch in the process of controlling the rotating speed of the driving motor to reach the first idle speed, the driving motor can output torque to an engine to increase the engine speed from zero to a threshold rotating speed lower than the first idle speed. When the engine speed is greater than the threshold rotating speed, the engine starts (ignites) and enters a running state. The HCUs can send to the engine an idle speed control command to enable the engine to run at an idle speed and a first idle speed instruction indicating that a target rotating speed is the first idle speed. In response to receiving the idle speed control command and the first idle speed instruction, the engine adjusts its rotating speed to the first idle speed.

In this embodiment, since the driving motor is controlled to be in the standby mode when its rotating speed reaches the first idle speed, and it is only in a power-up state without performing other operations in the standby mode, the power consumption of the driving motor can be reduced.

In step S32, send to the high-voltage battery a high-voltage disconnection instruction for disconnecting the main relay.

Proceed with the above high-voltage battery control method to step S32. The high-voltage disconnection instruction is used to disconnect the main positive relay and main negative relay of the high-voltage battery so that power is cut off between the high-voltage battery and loads.

After the high-voltage battery receives the high-voltage disconnection instruction, the main positive relay and the main negative relay of the high-voltage battery are disconnected. Since the high-voltage battery is in a high-voltage disconnection state, the hybrid vehicle is not powered up through the high-voltage battery.

Step S33: control the driving motor so that its rotating speed reaches a second idle speed, which is greater than the first idle speed.

In the embodiment of the present disclosure, the controlling the driving motor so that the rotating speed of the driving motor reaches the second idle speed can be implemented through the following: sending to the engine a second idle speed instruction indicating that the target rotating speed is the second idle speed, and controlling the rotating speed of the engine to reach the second idle speed, during which the engine drives the driving motor to reach the second idle speed.

The above implementation of controlling the driving motor so that the rotating speed of the driving motor reaches the second idle speed is only an example. This embodiment is not limited thereto. Those skilled in the art can use other related technologies to ensure the driving motor reaches the second idle speed.

Step S34: control the driving motor to output a predetermined voltage for heating the high-voltage battery.

In one possible implementation, the controlling the driving motor to output a predetermined voltage can be implemented through the following: sending a control mode instruction of a constant-voltage inverter mode to the driving motor, so that the driving motor supplies a predetermined voltage to a PTC heating apparatus for heating the high-voltage battery via a power module of the driving motor. Optionally, the driving motor supplies a predetermined voltage to the PTC apparatus via an IGBT module of the driving motor, and the predetermined voltage is usually a constant voltage.

According to the high-voltage battery control method and apparatus of the embodiment of the present disclosure, the rotating speed of the driving motor reaches the first idle speed and the main relay of the high-voltage battery is disconnected if the predetermined condition is satisfied when the main relay of the high-voltage battery is closed: the rotating speed of the driving motor reaches a second idle speed greater than the first idle speed, and the driving motor outputs a predetermined voltage for heating the high-voltage battery. Therefore, compared with the prior art that the power of a high-voltage battery is used for preheating a high-voltage battery through a PTC heating apparatus to increase the temperature of the high-voltage battery and supply power to the hybrid vehicle, the present disclosure has the advantage that the high-voltage battery is heated by the predetermined voltage output by the driving motor regardless of the power of the high-voltage battery, so as to increase the temperature of the high-voltage battery and supply power to the hybrid vehicle. So it can avoid the situation that the hybrid vehicle is unable to move due to the failure of high-voltage battery to supply power to the hybrid vehicle.

In addition, because the high-voltage battery control method of the hybrid vehicle according to the embodiments of the present disclosure can be implemented by utilizing existing components of the hybrid vehicle, without adding additional components to the hybrid vehicle, the cost of the hybrid vehicle will not be increased and the method is easy to implement.

In one possible implementation, after performing step S31, the high-voltage battery control method may also include: detecting whether a PTC heating apparatus for heating the high-voltage battery is in a normal state; and if the PTC heating device is in the normal state, performing step S32 to send to the high-voltage battery a high-voltage disconnection instruction for disconnecting the main relay.

After performing step S31, detect whether the PTC heating apparatus is in a normal state. If the PTC heating device is in an abnormal state, step S32 does not need to be performed at this point, which can avoid the situation of continuing to perform subsequent instructions regardless of the failure to heat the high-voltage battery due to the abnormality of the PTC heating apparatus. So the energy consumption of the high-voltage battery can be further reduced.

In one possible implementation, after performing step S31, the high-voltage battery control method may also include: detecting whether the DCDC is in a normal state; and if the DCDC is in the normal state, performing step S32 to send to the high-voltage battery a high-voltage disconnection instruction for disconnecting the main relay.

In one possible implementation, after performing step S31, the high-voltage battery control method may also include: detecting whether both the PTC heating apparatus and the DCDC are in a normal state; if both are in the normal state, performing step S32 to send to the high-voltage battery a high-voltage disconnection instruction for disconnecting the main relay.

Before sending the high-voltage disconnection instruction to the high-voltage battery, confirm that the PTC heating apparatus is in a normal state to ensure the heating of the high-voltage battery, and the DCDC in a normal state to ensure a low-voltage power supply.

In one possible implementation, the detecting whether the PTC heating apparatus is in a normal state can be implemented by the following: the HCUs send a standby mode instruction to the PTC heating apparatus: after receiving the instruction, the PTC detects whether it is in a normal state and feeds back to the HCUs; and the HCUs detect whether the PTC heating apparatus is in a normal state based on the state feedback of the PTC heating apparatus.

In one possible implementation, the detecting whether the DCDC is in a normal state can be implemented by the following: the HCUs send a standby mode instruction to the DCDC: after receiving the instruction, the DCDC detects whether it is in a normal state and feeds back to the HCUs; and the HCUs detect whether the DCDC is in a normal state based on the state feedback of the DCDC.

In one possible implementation, after performing step S32, the high-voltage battery control method may also include: detecting the voltage of the driving motor: if the voltage of the driving motor keeps dropping and the voltage is lower than a set voltage calibration value, determining that the high-voltage battery is in a high-voltage disconnection state, and then performing step S33 to control the driving motor so that the rotating speed of the driving motor reaches the second idle speed.

In one possible implementation, after performing step S33, the high-voltage battery control method may also include: detecting the actual rotating speed of the engine and the driving motor; if the rotating speed of both the engine and the driving motor is close to the second idle speed (if the deviation from the second idle speed is less than a set value), performing step S34 to control the driving motor to output a predetermined voltage for heating the high-voltage battery.

In one possible implementation, the HCUs can acquire the actual rotating speed of the driving motor by the following: the HCUs can receive, for example, a message sent by a driving motor controller, and then the HCUs can acquire the actual rotating speed of the driving motor based on the message, which can carry the current actual rotating speed of the driving motor.

In one possible implementation, the HCUs may acquire the actual rotating speed of the engine by the following: acquiring an input shaft rotating speed obtained by a gearbox input shaft rotating speed sensor, wherein the input shaft rotating speed is the actual rotating speed of the engine.

It should be understood that the above methods of acquiring the actual rotating speed of the driving motor and the engine are merely examples, and the embodiments are not limited thereto. Those skilled in the art may use other related technologies to acquire the actual rotating speed of the driving motor and the engine.

In one possible implementation, after performing step S34, the high-voltage battery control method may also include: detecting an output voltage of the driving motor: if the output voltage of the driving motor is stabilized near a predetermined value within a period of time, sending a voltage reduction control instruction to the DCDC and using the DCDC to provide a low-voltage power supply, and/or sending a heating instruction to the PTC heating apparatus, and using the PTC heating apparatus to heat the high-voltage battery.

In one possible implementation, after performing step S34, the high-voltage battery control method may also include: if it is detected that there is no heating request from the high-voltage battery or the driving motor fails or malfunctions, controlling a power module of the driving motor to enter the power-off process in which the power module of the driving motor is disconnected from the PTC heating apparatus and the DCDC.

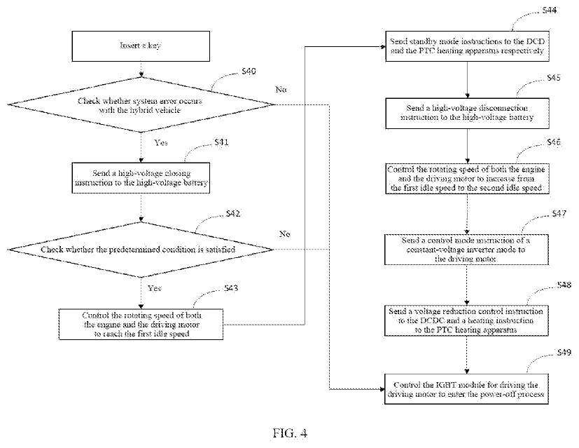

FIG. 4 is a flow diagram of a high-voltage battery control method of a hybrid vehicle according to one exemplary embodiment. This high-voltage battery control method can be used in a hybrid vehicle as shown in FIG. 1, specifically including the following procedures:

In step S40, check whether system error occurs with the hybrid vehicle when it is detected that a key of the hybrid vehicle is inserted into an ON position. If there is no system error, perform step S41; if system error occurs, perform step S49.

In step S41, the HCUs send to the high-voltage battery a high-voltage closing instruction for closing the main relay (including the precharge process) to start the high-voltage battery.

Perform the starting process of the high-voltage battery after the high-voltage battery receives the high-voltage closing instruction.

In step S42, the HCUs detect whether the following four conditions are met: a: the power of the high-voltage battery is less than or equal to the first calibration value; b: the hybrid vehicle is in a stationary state; c: the allowed charging power of the high-voltage battery is less than or equal to the second calibration value; d: the high-voltage battery needs to be heated: if the above four conditions are all met, perform step S43; otherwise, perform step S49.

In step S43, the HCUs control the rotating speed of both the engine and the driving motor to reach the first idle speed.

In step S44, the HCUs send the standby mode instructions to the DCDC and the PTC heating apparatus respectively.

After receiving the standby mode instructions, the DCDC and the PTC heating apparatus detect whether their states are normal and feed back to the HCUs. The HCUs detect whether the state feedbacks of the DCDC and the PTC are normal; and if the state feedbacks of both are normal, perform step S45.

In step S45, the HCUs send the high-voltage disconnection instruction to the high-voltage battery and detect the voltage of the driving motor: if the voltage of the driving motor drops and is lower than the set voltage calibration value, determine that the high-voltage battery is in the high-voltage disconnection state and continuously perform step S46.

In step S46, the HCUs control the rotating speed of both the engine and the driving motor to increase from the first idle speed to the second idle speed.

In step S47, the HCUs send the control mode instruction of the constant-voltage inverter mode to the driving motor, and control the IGBT module of the driving motor to output a constant voltage.

In step S48, the HCUs send the voltage reduction control instruction to the DCDC and a heating instruction to the PTC heating apparatus. The hybrid vehicle continuously runs at this stage.

In step S49, when the HCUs detect no heating request from the high-voltage battery or error or malfunction with the driving motor, the IGBT module for driving the driving motor is controlled to enter the power-off process.

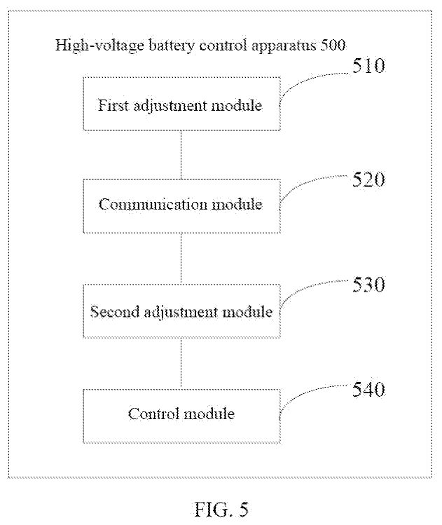

FIG. 5 is a block diagram of a high-voltage battery control apparatus of a hybrid vehicle according to one exemplary embodiment. The hybrid vehicle may be an HEV or a PHEV, including a high-voltage battery, an engine, a driving motor, and a clutch arranged between the engine and the driving motor. As shown in FIG. 5, the high-voltage battery control apparatus 500 may include a first adjustment module 510, a communication module 520, a second adjustment module 530 and a control module 540).

The first adjustment module 510 is configured to control the driving motor of the hybrid vehicle so that the rotating speed of the driving motor reaches a first idle speed if a predetermined condition is satisfied when a main relay of the high-voltage battery of the hybrid vehicle is closed. The communication module 520 is configured to send to the high-voltage battery a high-voltage disconnection instruction for disconnecting the main relay. The second adjustment module 530 is configured to control the driving motor so that the rotating speed of the driving motor reaches a second idle speed, and the second idle speed is greater than the first idle speed. The control module 540 is configured to control the driving motor to output a predetermined voltage for heating the high-voltage battery.

In one possible implementation, the predetermined condition includes: the high-voltage battery control apparatus receives a heating request for heating the high-voltage battery, and the power of the high-voltage battery is less than or equal to the first calibration value.

In one possible implementation, the predetermined condition further includes: the hybrid vehicle is in a stationary state; and/or the allowed charging power of the high-voltage battery is less than or equal to the second calibration value.

In one possible implementation, the first adjustment module 510 is further configured to: detect whether the PTC heating apparatus for heating the high-voltage battery is in a normal state after controlling the driving motor to ensure its rotating speed reaches a first idle speed; the communication module 520 is also configured to: send to the high-voltage battery a high-voltage disconnection instruction for disconnecting the main relay if the first adjustment module detects that the PTC heating apparatus is in the normal state.

In one possible implementation, the control module 540 is configured to control the driving motor to supply a predetermined voltage to the PTC apparatus for heating the high-voltage battery via the power module of the driving motor.

In one possible implementation, the high-voltage battery control apparatus 500 can be disposed in a hybrid vehicle (not shown).

In one possible implementation, the high-voltage battery control apparatus 500 can be disposed in HCUs (not shown) of a hybrid vehicle.

Regarding the apparatus in the above embodiment, the specific ways in which each module executes operations have been described in detail in the embodiments related to the method, and will not be described in detail here.

The above is only specific embodiments of the present disclosure, but the protection scope of the present disclosure is not limited thereto, and any change or substitution that may be easily thought of by those skilled in the art within the technical scope disclosed by the present disclosure should be covered within the protection scope of the present disclosure. Therefore, the protection scope of the present disclosure shall be subject to the protection scope of the claims.

1. A high-voltage battery control method for a hybrid vehicle, comprising:
when a main relay of a high-voltage battery of the hybrid vehicle is closed, controlling a driving motor of the hybrid vehicle so that a rotating speed of the driving motor reaches a first idle speed in response to determining that a predetermined condition is satisfied;
sending, to the high-voltage battery, a high-voltage disconnection instruction for disconnecting the main relay;
then controlling the driving motor so that the rotating speed of the driving motor reaches a second idle speed, the second idle speed being greater than the first idle speed; and
then controlling the driving motor to output a predetermined voltage for heating the high-voltage battery.

2. The high-voltage battery control method according to claim 1, wherein the predetermined condition includes:
a heating request for heating the high-voltage battery is received, and
a battery power of the high-voltage battery is less than or equal to a first calibration value.

3. The high-voltage battery control method according to claim 2, wherein the predetermined condition further includes at least one of:
the hybrid vehicle is in a stationary state; and
an allowed charging power of the high-voltage battery is less than or equal to a second calibration value.

4. The high-voltage battery control method according to claim 1, further comprising, after controlling the driving motor so that the rotating speed of the driving motor reaches the first idle speed,
determining whether a Positive Temperature Coefficient (PTC) heating apparatus used for heating the high-voltage battery is in a normal state; and
sending to the high-voltage battery a high-voltage disconnection instruction for disconnecting the main relay in that the PTC heating apparatus is in the normal state.

5. The high-voltage battery control method according to claim 1, wherein controlling the driving motor to output the predetermined voltage for heating the high-voltage battery includes:
controlling the driving motor to supply the predetermined voltage to a PTC heating apparatus for heating the high-voltage battery.

6. A hybrid vehicle, comprising:
a driving motor of the hybrid vehicle;
a high-voltage battery of the hybrid vehicle, the high-voltage battery including a main relay selectively switchable between an open state and a closed state; and
control logic configured to:
control the driving motor so that a rotating speed of the driving motor reaches a first idle speed if a predetermined condition is satisfied when the main relay of the high-voltage battery is in the closed state;
send, to the high-voltage battery, a high-voltage disconnection instruction for switching the main relay to the open state;
then control the driving motor so that the rotating speed of the driving motor reaches a second idle speed, the second idle speed being greater than the first idle speed; and
then control the driving motor to output a predetermined voltage for heating the high-voltage battery.

7. The hybrid vehicle according to claim 6, wherein the predetermined condition includes:
a heating request for heating the high-voltage battery is received; and
a battery power of the high-voltage battery is less than or equal to a first calibration value.

8. The hybrid vehicle according to claim 7, wherein the predetermined condition further includes at least one of:
the hybrid vehicle is in a stationary state; and
an allowed charging power of the high-voltage battery is less than or equal to a second calibration value.

9. The hybrid vehicle according to claim 6, wherein the control logic is further configured to:
determine whether a Positive Temperature Coefficient (PTC) heating apparatus for heating the high-voltage battery is in a normal state after controlling the driving motor so that the rotating speed of the driving motor reaches the first idle speed; and
send, to the high-voltage battery, a high-voltage disconnection instruction for switching the main relay to the open state in response to determining that the PTC heating apparatus is in the normal state.

10. The hybrid vehicle according to claim 6, further comprising a PTC heating apparatus for heating the high-voltage battery, wherein the control logic is further configured to control the driving motor to supply the predetermined voltage to the PTC heating apparatus for heating the high-voltage battery.

11. (canceled)

12. The high-voltage battery control method according to claim 4, further comprising controlling the driving motor to enter a power-off process in response to determining that the PTC heating apparatus is in an abnormal state.

13. The high-voltage battery control method according to claim 1, further comprising, after controlling the driving motor so that the rotating speed of the driving motor reaches the first idle speed:
determining whether a direct current power converter (DCDC) to supply power for low-voltage electrical apparatus of the hybrid vehicle is in a normal state; and
sending to the high-voltage battery a high-voltage disconnection instruction for disconnecting the main relay in response to determining that the DCDC is in the normal state.

14. The high-voltage battery control method according to claim 13, further comprising the driving motor to enter a power-off process in response to determining that the DCD is in an abnormal state.

15. The high-voltage battery control method according to claim 1, further comprising:
after sending the high-voltage disconnection instruction, detecting a voltage of the driving motor;
confirming that the main relay is disconnected based on the detected voltage being less than a set voltage calibration value; and
in response to confirming that the main relay is disconnected, controlling the driving motor so that the rotating speed of the driving motor reaches the second idle speed.

16. The high-voltage battery control method according to claim 1, further comprising controlling the driving motor to enter a power-off process in response to determining that the predetermined condition is not satisfied.

17. The hybrid vehicle according to claim 9, wherein the control logic is further configured to control the driving motor to enter a power-off process in response to determining that the PTC heating apparatus is in an abnormal state.

18. The hybrid vehicle according to claim 6, further comprising a direct current power converter (DCDC) to supply power for low-voltage electrical apparatus of the hybrid vehicle, wherein the control logic is further configured to:
determine whether the DCDC is in a normal state; and
send, to the high-voltage battery, a high-voltage disconnection instruction for switching the main relay to the open state in response to determining that the DCDC is in the normal state.

19. The hybrid vehicle according to claim 18, wherein the control logic is further configured to control the driving motor to enter a power-off process in response to determining that the DCD is in an abnormal state.

20. The hybrid vehicle according to claim 6, wherein the control logic is further configured to:
after sending the high-voltage disconnection instruction, detect a voltage of the driving motor;
confirm that the main relay is in the open state based on the detected voltage being less than a set voltage calibration value; and
in response to confirming that the main relay is in the open state, control the driving motor so that the rotating speed of the driving motor reaches the second idle speed.

21. The hybrid vehicle according to claim 6, wherein the control logic is further configured to control the driving motor to enter a power-off process in response to determining that the predetermined condition is not satisfied.
